(19) United States
(12) Patent Application Publication
(10) Pub. No.: US 2013/0003751 A1
(43) Pub. Date: Jan. 3, 2013

(54) METHOD AND SYSTEM FOR EXPONENTIAL BACK-OFF ON RETRANSMISSION

(75) Inventor: Lars Paul Huse, Oslo (NO)

(73) Assignee: ORACLE INTERNATIONAL CORPORATION, Redwood City, CA (US)

(21) Appl. No.: 13/173,589

(22) Filed: Jun. 30, 2011

(51) Int. Cl. H04L 12/56

(52) U.S. Cl. 370/412

(57) ABSTRACT

A method for exponential back-off on retransmission includes queuing a packet of a message in a completion module with an initial transport timeout, transmitting the packet of the message to a responder node, and applying an exponential timeout formula to the initial transport timeout to obtain an exponentially increased transport timeout for a first retransmission. After determining the initial transport timeout has lapsed, the method further includes requeuing the packet with the exponentially increased transport timeout, and retransmitting the packet to the responder node. The method further includes, after determining the exponentially increased transport timeout has lapsed, retransmitting the packet to the responder node.

### BACKGROUND

In network communications, reliable connections (both for remote copying and extended remote copying) are implemented by the requester having a timeout if an acknowledge is not received within a fixed programmable time after a packets is sent. Specifically, after the timeout has lapsed, the initial transmission followed by packet retransmission, where duplicated packets are ignored on the responder. For example, the timeout condition is generally detected in no less than the timeout interval and no more than four times the timeout interval. Once a timeout for a given request packet is detected, the requester may retry the request.

### SUMMARY

In general, in one aspect, the invention relates to a method for exponential back-off on retransmission. The method includes queuing a packet of a message in a completion module with an initial transport timeout, transmitting the packet of the message to a responder node, and applying an exponential timeout formula to the initial transport timeout to obtain an exponentially increased transport timeout for a first retransmission. After determining the initial transport timeout has lapsed, the method further includes requeuing the packet with the exponentially increased transport timeout, and retransmitting the packet to the responder node. The method further includes, after determining the exponentially increased transport timeout has lapsed, retransmitting the packet to the responder node.

In general, in one aspect, the invention relates to a communication adapter. The communication adapter includes transmitting processing logic configured to queue a packet of a message with an initial transport timeout, and apply an exponential timeout formula to the initial transport timeout to obtain an exponentially increased transport timeout for a first retransmission. The transmitting processing logic is further configured to, after determining the initial transport timeout has lapsed, requeue the packet with the exponentially increased transport timeout, and determine the exponentially increased transport timeout has lapsed. The communication adapter further includes a physical interface connector configured to transmit the packet of the message to a responder node, retransmit the packet to the responder node in response determining the initial transport timeout has lapsed, and in response to the transmitting processing logic determining the exponentially increased transport timeout has lapsed, retransmit the packet to the responder node.

In general, in one aspect, the invention relates to a non-transitory computer readable medium storing instructions for exponential back-off on retransmission. The instruction include functionality to queue a packet of a message in a completion module with an initial transport timeout, transmit the packet of the message to a responder node, and apply an exponential timeout formula to the initial transport timeout to obtain an exponentially increased transport timeout for a first retransmission. The instructions further include functionality to, after determining the initial transport timeout has lapsed, requeue the packet with the exponentially increased transport timeout, and retransmit the packet to the responder node. The instructions further include functionality to, after determining the exponentially increased transport timeout has lapsed, retransmit the packet to the responder node.

Other aspects of the invention will be apparent from the following description and the appended claims.

### BRIEF DESCRIPTION OF DRAWINGS

FIGS. 1-2 show schematic diagrams in one or more embodiments of the invention.

FIG. 3 shows a flowchart in one or more embodiments of the invention.

FIG. 4 shows an example in one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and an apparatus for exponential back-off on retransmission. Specifically, embodiments of the invention may be used to retransmit data using an exponentially increased timeout period.

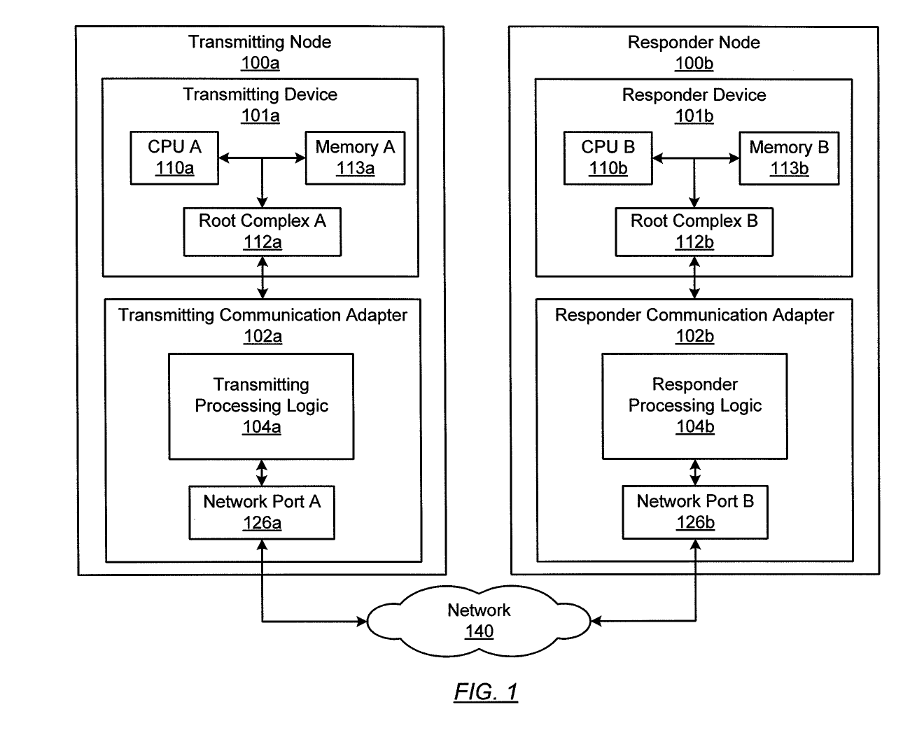

FIG. 1 shows a schematic diagram of a communication system in one or more embodiments of the invention. In one or more embodiments of the invention, the communication system includes a transmitting node (100a) and a responder node (100b). The transmitting node (100a) and responder node (100b) may be any type of physical computing device connected to a network (140). The network may be any type of network, such as an Infiniband® network, a local area network, a wide area network (e.g., Internet), or any other network now known or later developed. By way of an example of the transmitting node (100a) and the responder node (100b), the transmitting node (100a) and/or a responder node (100b) may be a host system, a storage device, or any other type of computing system. In one or more embodiments of the invention, for a particular message, the transmitting node (100a) is a system that sends the message and the responder node (100b) is a system that receives the message. In other words, the use of the words, “transmitting” and “responder”, refer to the roles of the respective systems for a particular message. The roles may be reversed for another message, such as a response sent from responder node (100b) to transmitting node (100b). For such a message, the responder node (100b) is a transmitting node and the transmitting node (100a) is a responder node. Thus, communication may be bi-directional in one or more embodiments of the invention.

In one or more embodiments of the invention, the transmitting node (100a) and responder node (100b) include a device (e.g., transmitting device (101a), responder device (101b)) and a communication adapter (e.g., transmitting communication adapter (102a), responder communication adapter (102b)). The device and the communication adapter are discussed below.

In one or more embodiments of the invention, the device (e.g., transmitting device (101a), responder device (101b)) includes at least a minimum amount of hardware necessary to process instructions. As shown in FIG. 1, the device includes hardware, such as a central processing unit (“CPU”) (e.g., CPU A (110a), CPU B (110b)), memory (e.g., memory A (113a), memory B (113b)), and a root complex (e.g., root complex A (112a), root complex B (112b)). In one or more embodiments of the invention, the CPU is a hardware processor component for processing instructions of the device. The CPU may include multiple hardware processors. Alternatively or additionally, each hardware processor may include multiple processing cores in one or more embodiments of the invention. In general, the CPU is any physical component configured to execute instructions on the device.

In one or more embodiments of the invention, the memory is any type of physical hardware component for storage of data. In one or more embodiments of the invention, the memory may be partitioned into separate spaces for virtual machines In one or more embodiments, the memory further includes a payload for transmitting on the network (140) or received from the network (140) and consumed by the CPU.

Continuing with FIG. 1, in one or more embodiments of the invention, the communication adapter (e.g., transmitting communication adapter (102a), responder communication adapter (102b)) is a physical hardware component configured to connect the corresponding device to the network (140). Specifically, the communication adapter is a hardware interface component between the corresponding device and the network. In one or more embodiments of the invention, the communication adapter is connected to the corresponding device using a peripheral component interconnect (PCI) express connection or another connection mechanism. For example, the communication adapter may correspond to a network interface card, an Infiniband® channel adapter (e.g., target channel adapter, host channel adapter), or any other interface component for connecting the device to the network. In one or more embodiments of the invention, the communication adapter includes logic (e.g., transmitting processing logic (104a), responder processing logic (104b)) for performing the role of the communication adapter with respect to the message. Specifically, the transmitting communication adapter (102a) includes transmitting processing logic (104a) and the responder communication adapter (102b) includes responder processing logic (104b) in one or more embodiments of the invention. Although not shown in FIG. 1, the transmitting communication adapter (102a) and/or responder communication adapter (102b) may also include responder processing logic and transmitting processing logic, respectively, without departing from the scope of the invention. The transmitting processing logic (104a) and the responder processing logic (104b) are discussed below.

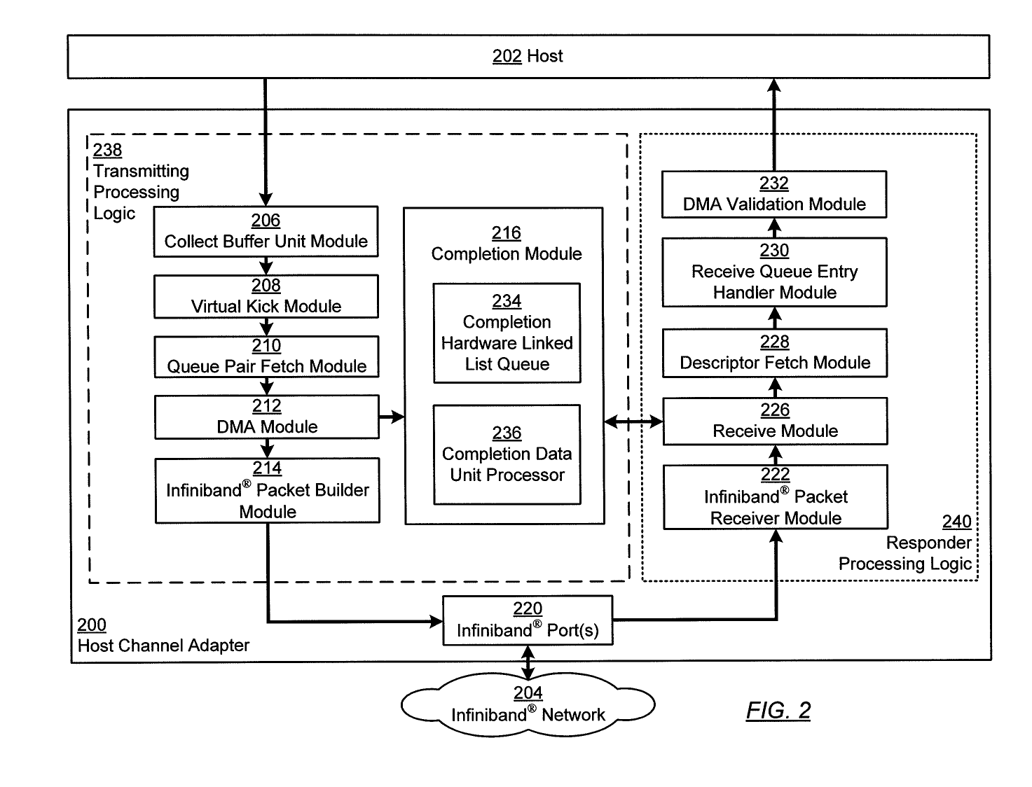

In one or more embodiments of the invention, the transmitting processing logic (104a) is hardware or firmware that includes functionality to receive the payload from the transmitting device (101a), partition the payload into packets with header information, and transmit the packets via the network port (126a) on the network (140). Further, in one or more embodiments of the invention, the transmitting processing logic (104a) includes functionality to determine whether an acknowledgement is not received for a packet or when an error message is received for a packet and retransmit the packet. In one or more embodiments of the invention, the transmitting processing logic (104a) may include an exponential timeout formula. The exponential timeout formula is an exponentially increasing function that defines when to retransmit a packet. In one or more embodiments of the invention, the exponential timeout formula may receive as input a retry count and return as output a subsequent timeout time. In one or more embodiments of the invention, the retry count is the number of times that retransmission is attempted by the transmitting processing logic (104a) to transmit a packet. The subsequent timeout time specifies the duration of time before perform another retransmission to transmit the packet. By way of an example, the transmitting processing logic for an Infiniband® network is discussed in further detail in FIG. 2 below.

Continuing with FIG. 1, as discussed above, packets are sent to, and received from, a responder node (100b). A responder node (100b) may correspond to a second host system in the Infiniband® network. Alternatively or additionally, the responder node (100b) may correspond to a data storage device used by the host to store and receive data.

In one or more embodiments of the invention, the responder node includes a responder communication adapter (102b) that includes responder processing logic (104b). Responder processing logic (104b) is hardware or firmware that includes functionality to receive the packets via the network (140) and the network port (126b) from the transmitting node (100a) and forward the packets to the responder device (101b). The responder processing logic (104b) may include functionality receive packets for a message from network (140). The responder processing logic may further include functionality to transmit an acknowledgement when a packet is successfully received. In one or more embodiments of the invention, the responder node may only transmit an acknowledgement when the communication channel, the packet, or the particular message of which the packet is a part requires an acknowledgement. For example, the communication channel may be in a reliable transmission mode or an unreliable transmission mode. In the reliable transmission mode, an acknowledgement is sent for each packet received. In the unreliable transmission mode, an acknowledgement is not received.

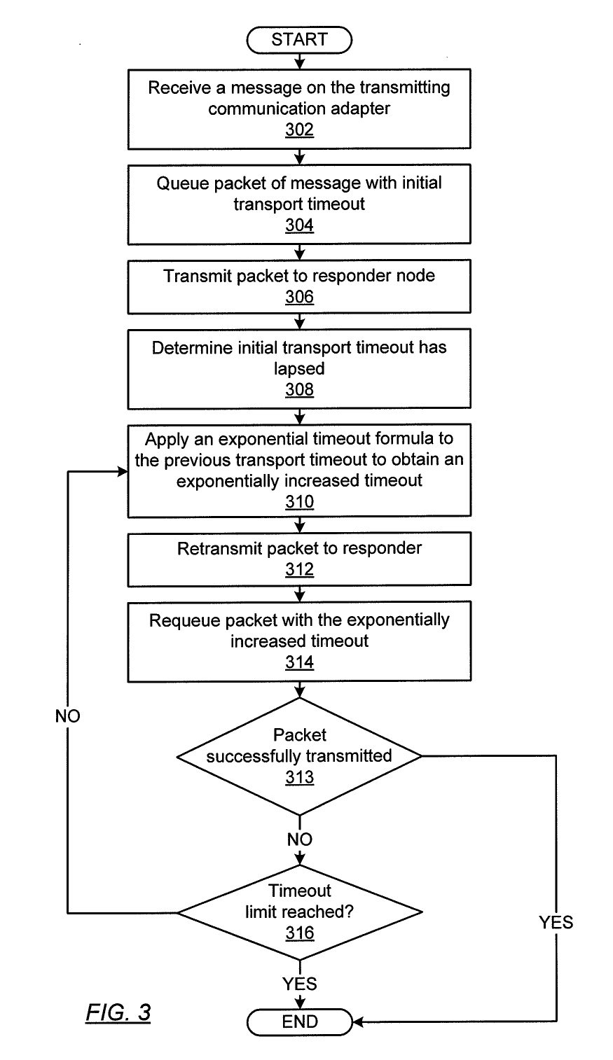

The responder processing logic (104b) may further include functionality to send error message if the packet is not successfully received or cannot be processed. The error message may include an instruction to retry sending the message after a predefined period of time. The responder processing logic (104b) may include functionality to perform similar steps described in FIG. 3 to define the predefined period of time using an exponential timeout formula.

Alternatively, the responder processing logic (104b) may transmit packets to the responder device (101b) as packets are being received. By way of an example, the responder processing logic for an Infiniband® network is discussed in further detail in FIG. 2 below.

Although not described in FIG. 1, software instructions to perform embodiments of the invention may be stored on a non-transitory computer readable medium such as a compact disc (CD), a diskette, a tape, or any other computer readable storage device. For example, the transmitting processing logic and/or the responder processing logic may be, in whole or in part, stored as software instructions on the non-transitory computer readable medium. Alternatively or additionally, the transmitting processing logic and/or receiving processing logic may be implemented in hardware and/or firmware.

As discussed above, FIG. 1 shows a communication system for transmitting and responder messages. FIG. 2 shows a schematic diagram of a communication adapter when communication adapter is a host channel adapter (200) and the network is an Infiniband® network in one or more embodiments of the invention.

As shown in FIG. 2, the host channel adapter (200) may include a collect buffer unit module (206), a virtual kick module (208), a queue pair fetch module (210), a direct memory access (DMA) module (212), an Infiniband® packet builder module (214), one or more Infiniband® ports (220), a completion module (216), an Infiniband® packet receiver module (222), a receive module (226), a descriptor fetch module (228), a receive queue entry handler module (230), and a DMA validation module (232). In the host channel adapter of FIG. 2, the host channel adapter includes both transmitting processing logic (238) for sending messages on the Infiniband® network (204) and responder processing logic (240) for responder messages from the Infiniband® network (204). In one or more embodiments of the invention, the collect buffer unit module (206), virtual kick module (208), queue pair fetch module (210), direct memory access (DMA) module (212), Infiniband® packet builder module (214), and completion module (216) may be components of the transmitting processing logic (238). The Infiniband® packet receiver module (222), receive module (226), descriptor fetch module (228), receive queue entry handler module (230), and DMA validation module (232) may be components of the responder processing logic (240). As shown, the completion module (216) may be considered a component of both the transmitting processing logic (238) and the responder processing logic (240) in one or more embodiments of the invention.

In one or more embodiments of the invention, each module may correspond to hardware and/or firmware. Each module is configured to process data units. Each data unit corresponds to a command or a received message or packet. For example, a data unit may be the command, an address of a location on the communication adapter storing the command, a portion of a message corresponding to the command, a packet, an identifier of a packet, or any other identifier corresponding to a command, a portion of a command, a message, or a portion of a message.

The dark arrows between modules show the transmission path of data units between modules as part of processing commands and received messages in one or more embodiments of the invention. Data units may have other transmission paths (not shown) without departing from the invention. Further, other communication channels and/or additional components of the host channel adapter (200) may exist without departing from the invention. Each of the components of the resource pool is discussed below.

The collect buffer controller module (206) includes functionality to receive command data from the host and store the command data on the host channel adapter. Specifically, the collect buffer controller module (206) is connected to the host and configured to receive the command from the host and store the command in a buffer. When the command is received, the collect buffer controller module is configured to issue a kick that indicates that the command is received.

In one or more embodiments of the invention, the virtual kick module (208) includes functionality to load balance commands received from applications. Specifically, the virtual kick module is configured to initiate execution of commands through the remainder of the transmitting processing logic (238) in accordance with a load balancing protocol.

In one or more embodiments of the invention, the queue pair fetch module (210) includes functionality to obtain queue pair status information for the queue pair corresponding to the data unit. Specifically, per the Infiniband® protocol, the message has a corresponding send queue and a receive queue. The send queue and receive queue form a queue pair. Accordingly, the queue pair corresponding to the message is the queue pair corresponding to the data unit in one or more embodiments of the invention. The queue pair state information may include, for example, sequence number, address of remote receive queue/send queue, whether the queue pair is allowed to send or allowed to receive, and other state information.

In one or more embodiments of the invention, the DMA module (212) includes functionality to perform DMA with host memory. The DMA module may include functionality to determine whether a command in a data unit or referenced by a data unit identifies a location in host memory that includes payload. The DMA module may further include functionality to validate that the process sending the command has necessary permissions to access the location, and to obtain the payload from the host memory, and store the payload in the DMA memory. Specifically, the DMA memory corresponds to a storage unit for storing a payload obtained using DMA.

Continuing with FIG. 2, in one or more embodiments of the invention, the DMA module (212) is connected to an Infiniband® packet builder module (214). In one or more embodiments of the invention, the Infiniband® packet builder module includes functionality to generate one or more packets for each data unit and to initiate transmission of the one or more packets on the Infiniband® network (204) via the Infiniband® port(s) (220). In one or more embodiments of the invention, the Infiniband® packet builder module may include functionality to obtain the payload from a buffer corresponding to the data unit, from the host memory, and from an embedded processor subsystem memory.

In one or more embodiments of the invention, the completion module (216) includes functionality to manage packets for queue pairs set in reliable transmission mode. Specifically, in one or more embodiments of the invention, when a queue pair is in a reliable transmission mode, then the responder channel adapter of a new packet responds to the new packet with an acknowledgement message indicating that transmission completed or an error message indicating that transmission failed. The completion module (216) includes functionality to manage data units corresponding to packets until an acknowledgement is received or transmission is deemed to have failed (e.g., by a timeout).

In one or more embodiments of the invention, the completion module (216) includes a completion hardware linked list queue (234) and a completion data unit processor (236). Each entry in the completion hardware linked list queue includes functionality to store a data unit corresponding to packet(s) waiting for an acknowledgement or a failed transmission or waiting for transmission to a next module. Specifically, in one or more embodiments of the invention, a packet may be deemed queued or requeued when a data unit corresponding to the packet is stored in the hardware linked list queue.

In one or more embodiments of the invention, the completion data unit processor (236) includes functionality to determine when an acknowledgement message is received, an error message is received, or a transmission times out. Transmission may time out, for example, when a maximum transmission time elapses since sending a message and an acknowledgement message or an error message has not been received. Thus, the completion data unit processor may be configured to enforce timeouts of messages sent to responder nodes. The timeouts may include a default constant timeout (e.g., transport timeout of 4.096 microseconds) and a dynamic timeout (e.g., exponentially backoff timeout). The completion data unit processor may be configured to determine whether the default or dynamic timeout should be used based on a single mode bit associated with a queue pair. The completion data unit processor further includes functionality to update the corresponding modules (e.g., the DMA module and the collect buffer module to retransmit the message or to free resources allocated to the command).

In one or more embodiments of the invention, the completion module (216) is configured to signal a send queue scheduler (not shown) when transmission has failed. In one or more embodiments of the invention, the send queue scheduler may be located on the host or the host channel adapter. If the packet is no longer stored on the host channel adapter (200), the send queue scheduler may include functionality to obtain the packet from the host, such as from a send queue on the host, an initiate retransmission of the packet. In one or more embodiments of the invention, the retransmission may be performed by reprocessing the packet through the transmitting processing logic. The completion module (216) may be further configured to increase the transport timeout period for a retransmitted packet (i.e., the period of time that the completion module (216) will allow to elapse before informing the collect buffer module that no acknowledgment message for the packet has been received).

In one or more embodiments of the invention, the completion module (216) does not receive an acknowledgement message for a transmitted packet. This may occur, for example, when a packet is lost during transmission across the Infiniband® network or when the destination component has failed. In these cases, the packet may be retransmitted after a timeout period, during which time the point of transmission failure may have been resolved.

In one or more embodiments of the invention, the completion module (216) is configured to adjust the transport timeout period relative to the previously expired transport timeout period. For example, a packet that was retransmitted after the expiration of a transport timeout period of X microseconds may then be associated with a transport timeout period of two times X microseconds. Further, in one or more embodiment of the invention, the subsequent transport timeout period may be calculated using the number of previous transmissions made without acknowledgment.

In one or more embodiments of the invention, the completion module (216) may be configured to calculate subsequent transport timeout periods using a exponential timeout formula. In one embodiment of the invention, the exponential timeout formula may calculate a subsequent transport timeout as exponentially larger than the previously expired transport timeout. For example, the completion module may be configured to calculated a subsequent transport timeout period as 4.096 microseconds times two to a power equal to the transport timeout period plus the number of previous transmissions.

In one or more embodiments of the invention, the completion module (216) includes functionality to receive an acknowledgement message from a responder channel adapter. An acknowledgment message may indicate that a referenced packet has been received by the responder channel adapter. In one embodiment of the invention, the responder channel adapter may send an error message (i.e., a negative acknowledgement message) that indicates a referenced packet was not properly received (e.g., the received packet was corrupted). In one embodiment of the invention, the negative acknowledgement message may also contain other information. This information may include a request to stop transmitting packets, or to wait a specified period of time before resuming transmission.

In one or more embodiments of the invention, the Infiniband packet receiver module (222) includes functionality to receive packets from the Infiniband® port(s) (220). In one or more embodiments of the invention, the Infiniband® packet receiver module (222) includes functionality to perform a checksum to verify that the packet is correct, parse the headers of the received packets, and place the payload of the packet in memory. In one or more embodiments of the invention, the Infiniband® packet receiver module (222) includes functionality to obtain the queue pair state for each packet from a queue pair state cache. In one or more embodiments of the invention, the Infiniband® packet receiver module includes functionality to transmit a data unit for each packet to the receive module (226) for further processing.

In one or more embodiments of the invention, the receive module (226) includes functionality to validate the queue pair state obtained for the packet. The receive module (226) includes functionality to determine whether the packet should be accepted for processing. In one or more embodiments of the invention, if the packet corresponds to an acknowledgement or an error message for a packet sent by the host channel adapter (200), the receive module includes functionality to update the completion module (216).

Additionally or alternatively, the receive module (226) includes a queue that includes functionality to store data units waiting for one or more reference to buffer location(s) or waiting for transmission to a next module. Specifically, when a process in a virtual machine is waiting for data associated with a queue pair, the process may create receive queue entries that reference one or more buffer locations in host memory in one or more embodiments of the invention. For each data unit in the receive module hardware linked list queue, the receive module includes functionality to identify the receive queue entries from a host channel adapter cache or from host memory, and associate the identifiers of the receive queue entries with the data unit.

In one or more embodiments of the invention, the descriptor fetch module (228) includes functionality to obtain descriptors for processing a data unit. For example, the descriptor fetch module may include functionality to obtain descriptors for a receive queue, a shared receive queue, a ring buffer, and the completion queue.

In one or more embodiments of the invention, the receive queue entry handler module (230) includes functionality to obtain the contents of the receive queue entries. In one or more embodiments of the invention, the receive queue entry handler module (230) includes functionality to identify the location of the receive queue entry corresponding to the data unit and obtain the buffer references in the receive queue entry. In one or more embodiments of the invention, the receive queue entry may be located on a cache of the host channel adapter (200) or in host memory.

In one or more embodiments of the invention, the DMA validation module (232) includes functionality to perform DMA validation and initiate DMA between the host channel adapter and the host memory. The DMA validation module includes functionality to confirm that the remote process that sent the packet has permission to write to the buffer(s) referenced by the buffer references, and confirm that the address and the size of the buffer(s) match the address and size of the memory region referenced in the packet. Further, in one or more embodiments of the invention, the DMA validation module (232) includes functionality to initiate DMA with host memory when the DMA is validated.

FIG. 3 shows a flowchart of a method for exponential back-off on retransmission. While the various steps in the flowchart are presented and described sequentially, some or all of the steps may be executed in different orders, may be combined or omitted, and some or all of the steps may be executed in parallel. Further, in one or more of the embodiments of the invention, one or more of the steps described below may be omitted, repeated, and/or performed in a different order. In addition, additional steps, omitted in FIG. 3, may be included in performing this method. Accordingly, the specific arrangement of steps shown in FIG. 3 should not be construed as limiting the scope of the invention.

In Step 302, a message is received on the transmitting communication adapter. For example, the transmitting communication adapter may receive a request from the transmitting device to initiate sending a message. The request may or may not include the message to be sent. If the request does not include the message, then the message may be obtained from a location in host memory designated in the request in one or more embodiments of the invention.

In Step 304, a packet of the message is queued for transmission using an initial transport timeout period. In other words, after the packet is transmitted to the receiving host, the initial transport timeout period will be used to determine when the packet transmission is determined to have failed and should be retried. In one or more embodiments of the invention, the initial timeout period may be a default period, a period defined by a communication library, or a period set by a developer and encode in an application sending the message. In Step 306, the packet is transmitted to the receiving host. In this case, the queue pair of the packet may specify the transport timeout period.

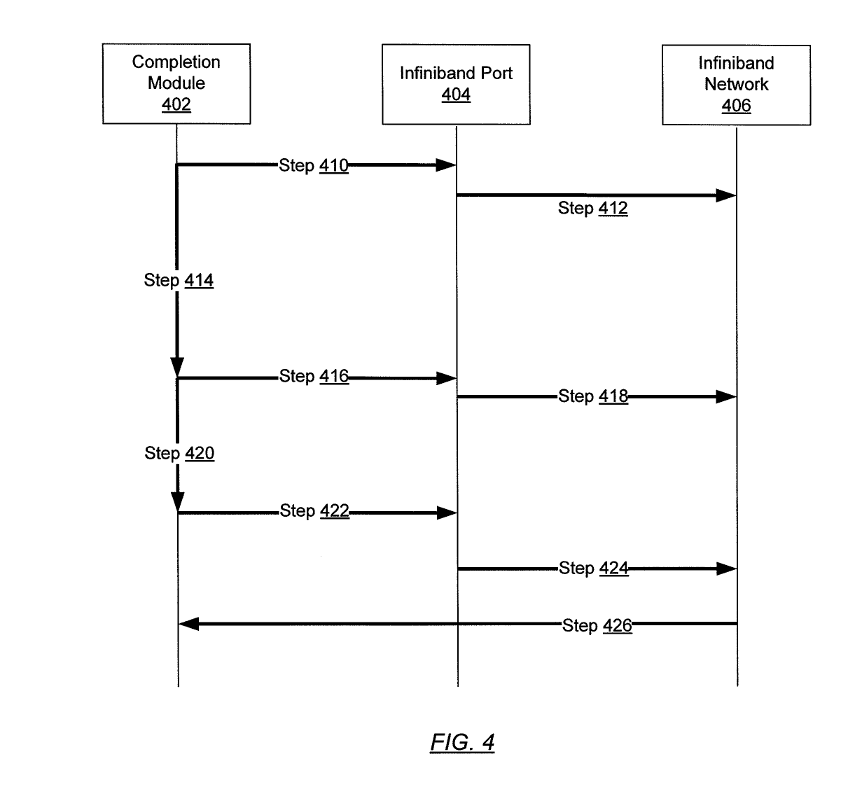

At this stage, an acknowledgment may be received indicating that the packet is successfully transmitted within the initial timeout period. In such a scenario, the flow may end and a completion may be sent to the host. However, for the purpose of the discussion of FIGS. 3 and 4, consider the scenario in which the packet is not successfully transmitted within the initial timeout period.

In Step 308, the completion module determines that the initial transport timeout period has lapsed. In Step 310, the completion module applies an exponential timeout formula to the previous transport timeout to obtain an exponentially increased timeout. In one embodiment of the invention, the transport timeout period is exponentially increased as a result of applying the exponential timeout formula. Specifically, the exponential timeout formula may be calculated as a constant multiplier*2^{(Local ACK timeout+retry count)}, where local ACK (acknowledgement) timeout is a default transport timeout and retry count is the number of retries of the packet transmission. In one or more embodiments of the invention, the constant multiplier is 4.096 microseconds. For example, if the lack ACK timeout is 1, the transport timeout would be calculated as (1) 4.096 microseconds for the first try of a transmission, (2) 8.192 microseconds for the second try of a transmission, (3) 16.384 microseconds for the third try of a transmission, etc. Although the above describes one exponential timeout formula for increasing the timeout, other exponential timeout formulas may be used without departing from the invention. Further, alternative equivalent forms of the above equation may be used without departing from the scope of the invention. For example, rather than using the formula: X*2^{(local ACK timeout+retry count)}, where X is the constant multiplier in the equation, Y*2^{(retry count)} may be used, where Y=X*2^{(Local ACK timeout)}. Thus, the specifying of a particular equation in the application and the claims includes equivalent forms of the particular equation.

In Step 312, the packet is retransmitted to the responder. Further, in Step 314, the packet is re-queued with the exponentially increased transport timeout. Re-queuing the packet may include re-storing the packet or an identifier of the packet in the completion module, or only updating the exponential increased transport timeout associated with the packet. Other methods may be used to re-queue the packet without departing from the scope of the invention

In Step 314, the completion module determines whether the retransmitted packet has been successfully transmitted (i.e., an acknowledgement message has been received). If the packet has been successfully transmitted, then the flow ends. However, if the packet was not successfully transmitted (i.e., the recalculated transport timeout period has lapsed and no acknowledgement message has been received), then in Step 316, the completion module determines whether the number of times the packet has been retransmitted exceeds the timeout limit (i.e., the maximum number of times a packet will be retransmitted). If the timeout limit has not been reached, then, in Step 310, the transport timeout period is increased using the exponential timeout formula. If at Step 316, the timeout limit has been reached, then the flow ends.

FIG. 4 shows a flow chart example for exponential back-off on retransmission. In one or more embodiments of the invention, one or more of the steps shown in FIG.4 may be omitted, repeated, and/or performed in a different order than that shown in FIG.4. Accordingly, the specific arrangement of steps shown in FIG.4 should not be construed as limiting the scope of the invention. The following example is provided for exemplary purposes only and accordingly should not be construed as limiting the invention.

In Step 410, the completion module (402) queues a packet with an initial transport timeout period of 4.096 microseconds, and the packet is sent to the Infiniband® Port (404) for transmission. In Step 412, the packet is transmitted on the Infiniband® network (406) addressed to a Responder HCA (not shown). At Step 414, the completion module (402) determines that the initial transport timeout period has lapsed, and no acknowledgement message has been received. Also at Step 414, the completion module (402) recalculates the transport timeout period using a exponential timeout formula. For the purposes of this example, assume that the exponential timeout formula is: transmission timeout=4.096 microseconds ×2̂ (retry count). Because this is the first retry, the retry count is 1. The recalculated timeout period is therefore calculated as 8.192 microseconds.

In Step 416, the packet is queued for retransmission using the recalculated transport timeout period of 8.192 microseconds. At Step 418, the packet is again transmitted on the Infiniband® network (406) addressed to the Responder HCA. At Step 420, the completion module (402) determines that the recalculated transport timeout period of 8.192 microseconds has lapsed, and no acknowledgement message has been received. Also at Step 420, the completion module (402) again recalculates the transport timeout period using the exponential timeout formula, using a retry count of 2. This results in a recalculated transport timeout period of 16.384 microseconds. Using the example exponential timeout formula, as the retry count increases, the recalculated transport timeout will increase exponentially.

In Step 422, the packet is again queued for retransmission using the recalculated transport timeout period of 16.384 microseconds. At Step 424, the packet is again transmitted on the Infiniband® network (406) addressed to the Responder HCA. At Step 426, the completion module (402) determines that an acknowledgement message has been received, and prepares to transmit the next packet.

In one or more embodiments of the invention, the different retransmission types may assist in handling different types of failures. Specifically, short retransmission time allows for short failure recovery when the failure is a packet loss. For example, the retransmission time is appropriate when the particular packet is corrupted. The long retransmission time allows for a longer time for any failed components to recover. For example, if there is a loss of service by a failed component, then the failed component may need to have time to recover before the failed component can accept packets. The long retransmission time allows for the failed component to appropriately recover. By having both a short retransmission time and a longer retransmission time when previous retransmissions fail, embodiments of the invention are able to effectively handle both types of failures even when the exact failure affecting the packet is unknown.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for exponential back-off on retransmission, the method comprising:
queuing a packet of a message in a completion module with an initial transport timeout;
transmitting the packet of the message to a responder node;
applying an exponential timeout formula to the initial transport timeout to obtain an exponentially increased transport timeout for a first retransmission;
after determining the initial transport timeout has lapsed:
requeuing the packet with the exponentially increased transport timeout; and
retransmitting the packet to the responder node; and
after determining the exponentially increased transport timeout has lapsed:
retransmitting the packet to the responder node.

2. The method of claim 1, further comprising iteratively:
applying the exponential timeout formula to a previous exponentially increased transport timeout to obtain a subsequent exponentially increased transport timeout; and
after determining the previous exponentially increased transport timeout has lapsed:
requeuing the packet with the subsequent exponentially increased transport timeout; and
retransmitting the packet to the responder node.

3. The method of claim 2, wherein iteratively applying the exponential timeout formula is limited to a maximum of 7 retries.

4. The method of claim 1, wherein the exponential timeout formula is T=F*2^{(retry}^{_{—}}^{count)}, wherein T represents the exponentially increased transport timeout, F is a constant multiplier and retry count is a number of retransmissions.

5. The method of claim 4, wherein the retry count is a 3 bit value.

6. The method of claim 1, wherein the packet is transmitted and retransmitted on an Infiniband® network.

7. The method of claim 1, further comprising:
selecting the exponential timeout formula based on a single mode bit in a queue pair corresponding to the message.

8. A communication adapter comprising:
transmitting processing logic configured to:
queue a packet of a message with an initial transport timeout;
apply an exponential timeout formula to the initial transport timeout to obtain an exponentially increased transport timeout;
after determining the initial transport timeout has lapsed:
requeue the packet with the exponentially increased transport timeout; and
determine the exponentially increased transport timeout has lapsed;
a physical interface connector configured to:
transmit the packet of the message to a responder node;
retransmit the packet to the responder node in response determining the initial transport timeout has lapsed; and
in response to the transmitting processing logic determining the exponentially increased transport timeout has lapsed, retransmit the packet to the responder node.

9. The communication adapter of claim 8,
wherein the transmitting processing logic is further configured to:
apply the exponential timeout formula to a previous exponentially increased transport timeout to obtain a subsequent exponentially increased transport timeout; and
after determining the previous exponentially increased transport timeout has lapsed: requeue the packet with the subsequent exponentially increased transport timeout;
wherein the physical interface connector is further configured to:
retransmit the packet to the responder node after determining the previous exponentially increased transport timeout has lapsed.

10. The communication adapter of claim 8, wherein the transmitting processing logic comprises a completion module, wherein the completion module is configured to:
requeue the packet with a current timeout period;
determining when the current timeout period lapsed; and
trigger retransmission of the packet based on the current timeout lapsing.

11. The communication adapter of claim 10, wherein the completion module comprises a hardware linked list queue, and wherein requeuing the packet comprises storing a data unit corresponding to the packet in a hardware linked queue.

12. The communication adapter of claim 11, wherein the completion module comprises a completion data unit processor for processing the data unit, wherein the completion data unit processing implements the exponential timeout formula, and wherein the wherein the exponential timeout formula is T=F*2^{(retry}^{_{—}}^{count)}, wherein T represents the exponentially increased transport timeout, F is a constant multiplier and retry count is a number of retransmissions.

13. The communication adapter of claim 8, further comprising:
a single mode bit in a queue pair corresponding to the message, wherein the single mode bit specifies whether to select the exponential timeout formula.

14. A non-transitory computer readable medium storing instructions for exponential back-off on retransmission, the instructions comprising functionality to:
queue a packet of a message in a completion module with an initial transport timeout;
transmit the packet of the message to a responder node;
apply an exponential timeout formula to the initial transport timeout to obtain an exponentially increased transport timeout;
after determining the initial transport timeout has lapsed:
requeue the packet with the exponentially increased transport timeout; and
retransmit the packet to the responder node; and
after determining the exponentially increased transport timeout has lapsed:
retransmit the packet to the responder node.

15. The non-transitory computer readable medium of claim 14, the instructions further comprising functionality to:
apply the exponential timeout formula to a previous exponentially increased transport timeout to obtain a subsequent exponentially increased transport timeout; and
after determining the previous exponentially increased transport timeout has lapsed:
requeue the packet with the subsequent exponentially increased transport timeout; and
retransmit the packet to the responder node.

16. The non-transitory computer readable medium of claim 15, wherein iteratively applying the exponential timeout formula is limited to a maximum of 7 retries.

17. The non-transitory computer readable medium of claim 14, wherein the exponential timeout formula is T=F*2^{(retry}^{_{—}}^{count)}, wherein T represents the exponentially increased transport timeout, F is a constant multiplier and retry_count is a number of retransmissions.

18. The non-transitory computer readable medium of claim 17, wherein the retry count is a 3-bit value.

19. The non-transitory computer readable medium of claim 17, wherein the packet is transmitted and retransmitted on an Infiniband® network.

20. The non-transitory computer readable medium of claim 14, the instructions further comprising functionality to:
select the exponential timeout formula based on a single mode bit in a queue pair corresponding to the message.
